(19) United States
(12) Patent Application Publication
(10) Pub. No.: US 2008/0194149 A1
(43) Pub. Date: Aug. 14, 2008

(54) UNIFIED CONNECTING DEVICE

(75) Inventor: Kyung-Suk Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/961,154

(22) Filed: Dec. 20, 2007

(30) Foreign Application Priority Data
Feb. 14, 2007 (KR) 2007-15457

(51) Int. Cl. H01R 33/90

(52) U.S. Cl. 439/639

(57) ABSTRACT

A unified connecting device which includes: a memory card type connector inserted into a memory card socket provided in a portable electronic device; a plurality of sockets into which cables having different appearances and different functions can be inserted; and a connecting line to electrically connect the memory card type connector and the sockets.

### CROSS-REFERENCE TO RELATED APPLICATIONS

This application claims priority from Korean Patent Application No. 10-2007-0015457, filed Feb. 14, 2007, the contents of which is hereby incorporated herein by reference in its entirety, as if set forth fully herein.

### BACKGROUND OF THE INVENTION

1. Field of the Invention

The present general inventive concept relates to a connecting device, and more particularly, to a unified connecting device capable of connecting a portable electronic device and a plurality of cables.

2. Description of the Related Art

In recent years, as all industrial technologies including the semiconductor manufacturing technology have been rapidly developing, portable electronic devices having more improved functions and being slimmer and more compact are being manufactured in larger numbers.

For example, portable electronic devices such as a digital camera, a personal digital assistant (PDA), and a mobile phone support more functions and have more memories while being very slim and compact.

Further, most of the portable electronic devices respectively include a plurality of sockets to support more functions or to provide more memories. The sockets are mounted mostly on the side surfaces of the portable electronic device being slimmer and more compact.

FIG. 1 illustrates one example of a digital camera 10 among the portable electronic devices. As illustrated in FIG. 1, a plurality of sockets 15 are installed on the side surfaces of the conventional digital camera 10. That is, the conventional digital camera 10 includes a socket 11 into which a memory card 19 is inserted, a socket 13 into which a USB cable is inserted, and a socket 14 to which an IEEE 1394 firewire cable (hereinafter, referred to as firewire cable) is inserted, and a socket 12 into which a power source cable is inserted over the side surface of its body.

As another example, a mobile phone includes a socket into which a memory card is inserted, a socket into which a power source cable is inserted, a socket into which an earphone cable is inserted, and a socket into which a data cable for the mobile phone is inserted, which are all positioned on the side surface of its body.

Meanwhile, portable electronic devices tend to be slimmer and more compact due to requests for ‘convenience for portability’ of consumers.

However, since almost all the portable electronic devices include a plurality of sockets as described above, it is difficult to make them much slimmer and more compact. Therefore, in order to make the more recent portable electronic devices much slimmer and more compact, it is necessary to arrange a plurality of sockets in a simple way.

### SUMMARY OF THE INVENTION

The present general inventive concept provides a unified connecting device capable of connecting a plurality of cables having different appearances and different functions to one memory card socket.

The present general inventive concept also provides a unified connecting device capable of mutually connecting a portable electronic device and a plurality of cables having different appearances and different functions.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a unified connecting device comprising: a memory card type connector; and a plurality of sockets electrically connected to the memory card type connector.

The memory card type connector may be inserted into a memory card socket provided in a portable electronic device.

The memory card type connector may comprise a connector body having the form of a memory card and a plurality of terminals installed on one side of the connector body so that some portions of the terminals are exposed to the outside of the connector body.

A controller to individually support connections between the sockets and the memory card type connector may be installed inside the connector body.

Cables having different appearances and different functions may be inserted into the sockets, respectively.

The sockets may include at least two sockets selected from a group consisting of a socket into which a USB cable is inserted, a socket into which an IEEE 1394 firewire cable is inserted, a socket into which a power source cable is inserted, a socket into which an earphone cable is inserted, a socket into which an S video cable is inserted, and a socket into which a data cable for a mobile phone is inserted.

Detection sections to detect insertion of the cables may be provided in the sockets respectively.

The foregoing and/or other aspects and utilities of the present general inventive concept may also be achieved by providing a unified connecting device comprising: a memory card connector inserted into a memory card socket provided in a portable electronic device; a plurality of sockets into which cables having different appearances and different functions are inserted; and a connecting line electrically connecting the memory card type connector and the sockets.

The memory card type connector may comprise a connector body having the form of a memory card so as to be inserted into the memory card socket and a plurality of terminals installed on one side of the connector body so that some portions of the terminals are exposed to the outside of the connector body to be electrically connected to the memory card socket.

A controller to individually support connections between the sockets and the memory card type connector may be installed inside the connector body.

The sockets may include at least two sockets selected from a group comprising a socket into which a USB cable is inserted, a socket into which an IEEE 1394 firewire cable is inserted, a socket into which a power source cable is inserted, a socket into which an earphone cable is inserted, a socket into which an S video cable is inserted, and a socket into which a data cable for a mobile phone is inserted.

Detection sections to detect insertion of the cables may be provided in the sockets respectively.

The foregoing and/or other aspects and utilities of the present general inventive concept may also be achieved by providing a unified connecting device, comprising: a memory card type connector insertable into a memory port of a portable electronic device; a plurality of sockets to receive different types of cables with respect to each other; and a signal transmission part to transmit signals between the memory card type connector and the plurality of sockets.

The signal transmission part can include a connecting line to physically connect the plurality of sockets and the memory card type connector.

The unified connecting device can further include a controller disposed within the memory card type connector to sense a signal received through the signal transmission part from the sockets and to signal to the electronic device which type of cable has been received by a corresponding sockets.

A detection section can be connected to each of the sockets to detect when a corresponding cable has been connected thereto and to send the signal to the controller from the respective socket.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating a conventional portable electronic device;

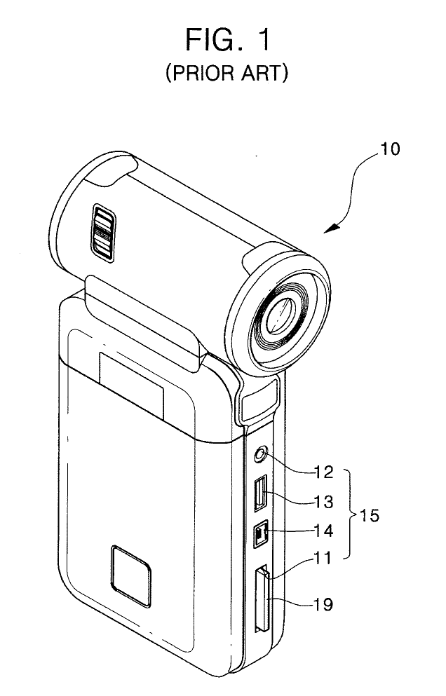

FIG. 2 is a perspective view illustrating a unified connecting device according to an embodiment of the present general inventive concept;

FIG. 3 is a perspective view illustrating a method of using the unified connecting device according to an embodiment of the present general inventive concept;

FIG. 4 is a perspective view illustrating a unified connecting device according to another embodiment of the present general inventive concept;

FIG. 5 is a perspective view illustrating a unified connecting device according to another embodiment of the present general inventive concept;

FIG. 6 is a block diagram illustrating the operational relation of the unified connecting device illustrated in FIG. 5; and

FIG. 7 is a perspective view illustrating a unified connecting device according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

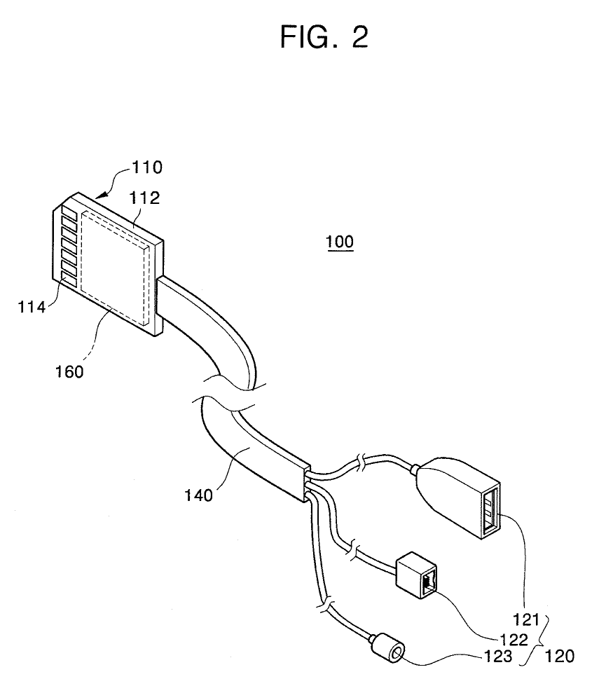

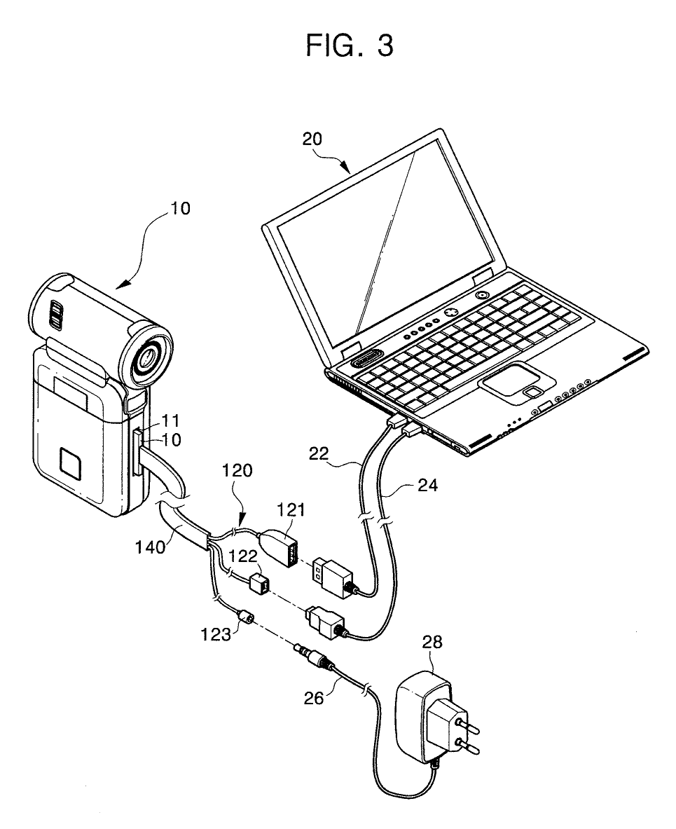

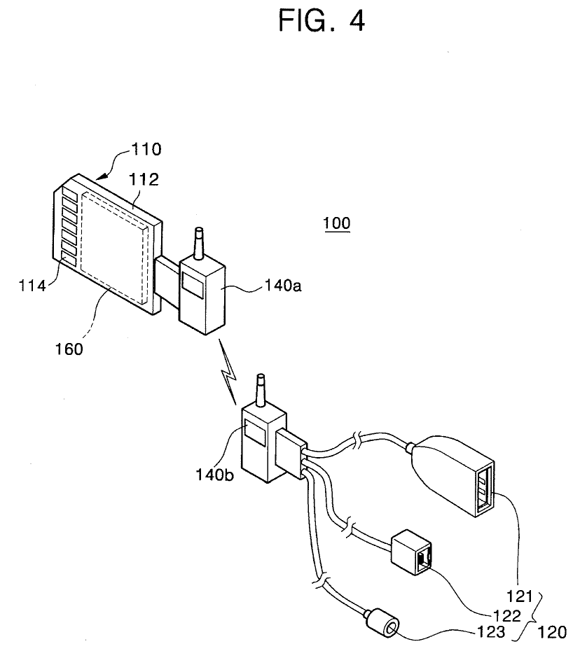

FIG. 2 is a perspective view illustrating a unified connecting device 100 according to an embodiment of the present general inventive concept. FIG. 3 is a perspective view illustrating a method of using the unified connecting device according to an embodiment of the present general inventive concept. FIG. 4 is a perspective view illustrating a unified connecting device according to another embodiment of the present general inventive concept;

Referring to FIGS. 2 and 3, the unified connecting device 100 according to the present embodiment can include a memory card type connector 110, a plurality of sockets 120 into which a plurality of cables having different appearances and different functions can be inserted respectively, and a connecting line 140 electrically connecting the memory card type connector 110 and the sockets 120. Alternatively, the connecting line 140 can be replaced with a wireless type unit 140a, 140b (see FIG. 4) to wirelessly transmit signals from each of the sockets 120 to the memory card type connector 110.

More particularly, the memory card type connector 110 includes a connector body 112 having the shape of a memory card, a plurality of terminals 114 installed on one side of the connector body 112, and a controller 160 installed in the interior of the connector body 112.

The connector body 112 has an appearance in the shape of a memory card. Therefore, the connector body 112 of the memory card connector 110 can be inserted into a memory card socket 11 provided in a portable electronic device 10 (see FIG. 3) or other type of electronic device. For example, the connector body 112 of the memory card type connector 110 can be inserted into a memory card socket of a portable electronic device such as a digital camera, a PDA, and a mobile phone.

Meanwhile, the memory cards which have been recently used include a smart media memory card, a secure digital memory card, a multimedia card, a compact flash card, and so on. Therefore, the connector body 112 of the memory card type connector 110 may take the form of any type of memory card.

For example, the connector body 112 of the memory card type connector 110 may take the form of a smart media memory card. However, the shape of the connector body 112 of the memory card type connector 110 is not limited to the shapes of the above-mentioned memory cards. That is, the connector body 112 of the memory card type connector 110 may have the form of a different memory card in addition to the above-mentioned memory cards.

The terminals 114 can include those for input/output of a power source, those for input/output of data and those for ground connections. The terminals 114 are installed on one side of the connector body 112 so that some portions of the terminals 114 are exposed to the outside of the connector body 112. Therefore, when the connector body 112 is inserted into the memory card socket 11 provided in the portable electronic device 10, the terminals 114 are electrically connected to the terminals inside the memory card socket 11 and are in charge of input/output of a power source, input/output of data, and ground connections.

The controller 160 is installed in the interior of the connector body 112 and individually supports the connections between the sockets 120 and the memory card connector 110. In other words, when a cable is inserted into one of the sockets 120, the controller 160 recognizes the type of the cable inserted into the socket 120 and supports the connection between the socket into which the cable is inserted and the memory card type connector 110 to properly connect the cable and the portable electronic device 10, which is to be connected to the cable, according to the type of the recognized cable, and thus to properly operate the cable and the portable electronic device 10.

As an example, when a USB cable 22 is inserted into one of the sockets of the unified connecting device 100, with the memory card type connector 110 thereof being inserted into the memory card socket 11 of the portable electronic device 10, the controller 160 recognizes that the cable inserted into one of the sockets 120 is the USB cable 22 through the form of a signal transferred through the USB cable 22 or through the form of supply of a power source, and then sets signal transfer/power source supply paths or systems to properly connect the recognized USB cable 22 and the portable electronic device 10 connected to the USB cable 22, and thus to properly operate the USB cable 22 and the portable electronic device 10. Accordingly, the USB cable 22 and the portable terminal 10 can be properly connected to each other and can be properly operated through the sockets 120 and the memory card type connector 110, i.e. through the unified connector 100.

As another example, when a power source cable 26 is inserted into one of the sockets 120, with the memory card type connector 110 being inserted into the memory card socket 11 of the portable electronic device 10, the controller 160 recognizes that the cable inserted into one of the sockets 120 is the power source cable 26 through the form of supply of a power source transferred through the power source cable 26. The controller 160 then sets a power source supply path or a power source supply system to properly connect the recognized power source cable 26 and the portable electronic device 10 to properly operate the power source cable 26 and the portable electronic device 10 together. Accordingly, the power source cable 26 and the portable electronic device 10 can be properly connected to each other and can be properly operated through the unified connecting device 100.

Further, the sockets 120 to which the plurality of cables are respectively inserted include a socket 121 into which a USB cable 22 is inserted, a socket 122 into which a firewire cable 24 is inserted, and a socket 123 into which a power source cable 26 is inserted. Therefore, any one of the USB cable 22, the firewire cable 24, and the power source cable 26 can be inserted into the sockets 120. The reference numeral 20 (see FIG. 3) represents a personal computer to which the USB cable 22 and the fire wire cable 24 are connected, and the reference numeral 28 represents a power source adapter to which the power cable 26 is connected.

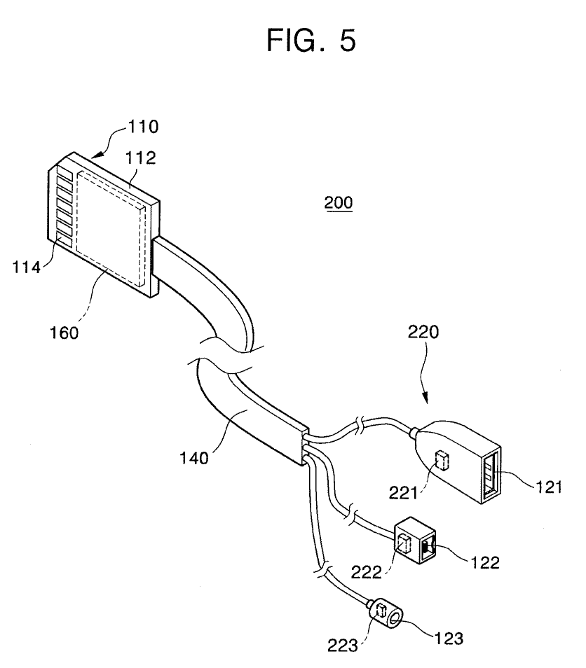

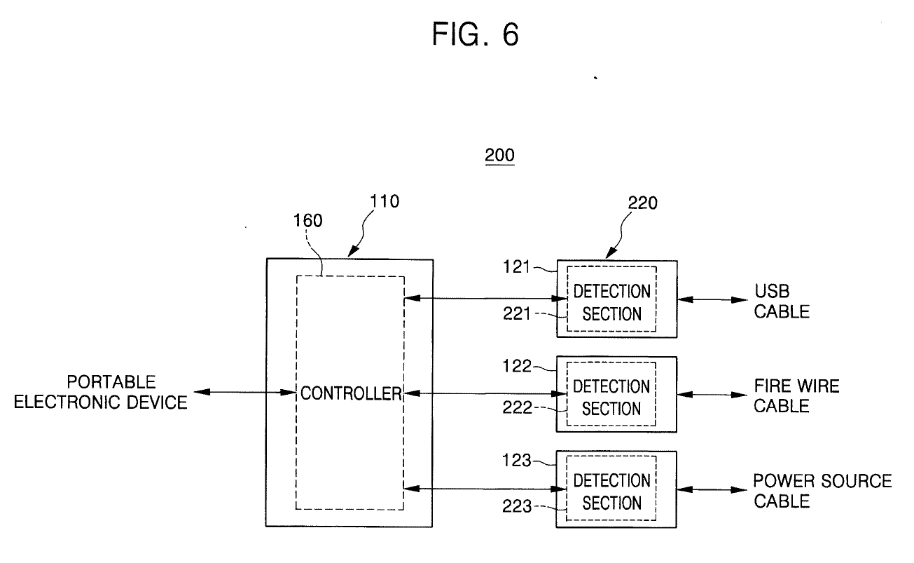

Meanwhile, the unified connecting device as described above can be realized by another embodiment as illustrated in FIGS. 5 and 6.

FIG. 5 is a perspective view illustrating a unified connecting device 200 according to another embodiment of the present invention. FIG. 6 is a block diagram for explaining the operational relation of the unified connecting device 200 shown in FIG. 5.

Referring to FIGS. 5 and 6, the unified connecting device 200 according to another embodiment of the present general inventive concept further includes detection sections 221, 222, and 223, in addition to a memory card type connector 110, a plurality of sockets 220 into which a plurality of cables having different appearances and different functions are respectively inserted, and a connecting line 140 electrically connecting the memory card type connector 110 and the sockets 220, which have been described above. The detection sections 221, 222, and 223 detect whether corresponding cables are respectively inserted into the sockets 220.

The detection sections 221, 222, and 223 are installed in the sockets 220, respectively, and detect insertion of the cables into the corresponding sockets. Therefore, when the detection sections 221, 222, and 223 detect the insertion of the cables into the sockets, they transmit corresponding values to a controller 160 of the memory card type connector 110. Then, the controller 160 supports the connection between the sockets into which the cables are inserted and the memory card type connector 110 according to the values transmitted from the detection sections 221, 222, and 223. As a result, the cables and a portable electronic device 10, which are connected to each other through the sockets and the memory card type connector 110, i.e. through the unified connecting device 200, can be properly connected to each other and can be properly operated.

Here, the detection sections 221, 222, and 223 can be realized in various forms. As an example, the detection sections 221, 222, and 223 may be ON/OFF switches which can be turned on and off according to the insertion states of the cables. In this case, when the cables are inserted into the sockets, the ON/OFF switches are converted into the opposite states in the ON or OFF states to transfer the insertion states of the cables to the controller 160.

As another example, the detection sections 221, 222, and 223 may be sensors, the initial values of which can be changed according to the insertion states of the cables. For example, the detection sections 221, 222, and 223 may be optical sensors whose amount of received light is changed according to the insertion states of the cables. In this case, one kind of a cable is inserted into the corresponding socket, the optical sensor recognizes the insertion of the cable through the change of the initial value, i.e. the amount of received light and transfers the recognized value to the controller 160.

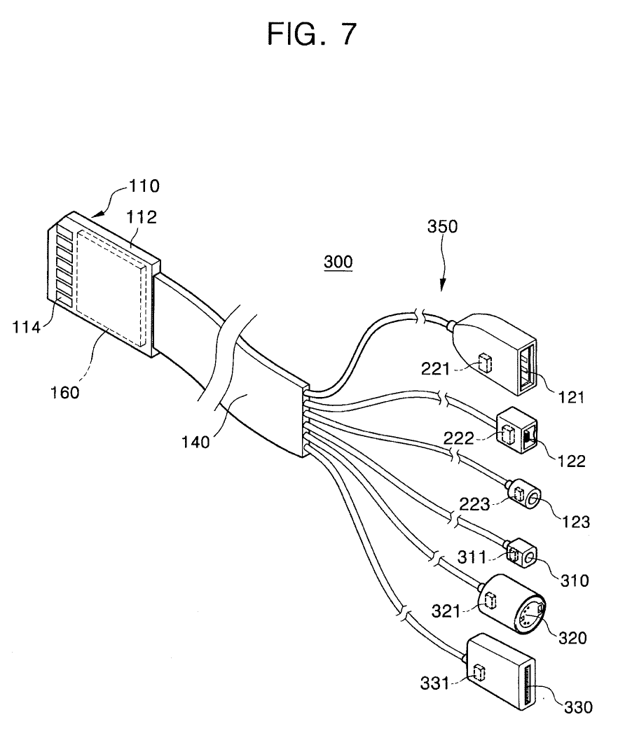

Further, another example of the unified connecting device can be realized according to another embodiment as illustrated in FIG. 7.

FIG. 7 is a perspective view illustrating a unified connecting device 300 according to another embodiment herein.

Referring to FIG. 7, the unified connecting device 300 according to the embodiment of FIG. 7 includes a memory card type connector 110 having an appearance in the form of a memory card and having a controller 160 disposed therein, a plurality of sockets 350 into which a plurality of cables having different appearances and different functions can be inserted, and connecting lines 140 electrically connecting the memory card type connector 110 and the sockets 350.

Then, the plurality of sockets 350 include a socket 121 into which a USB cable is inserted, a socket 122 into which a firewire cable is inserted, a socket 123 into which a power source cable is inserted, a socket 310 into which an earphone cable is inserted, a socket 320 into which an S video cable is inserted, and a socket 330 into which a data cable for a mobile data phone is inserted. Further, detection cables 221, 222, 223, 311, 321, and 331 detecting insertion of the cables into the sockets 350 are installed in the sockets 350, respectively.

Therefore, one of the USB cable, the firewire cable, the power source cable, the earphone cable, the S video cable, and the data cable for a mobile phone can be inserted into the sockets 350.

In this case, each of the detection sections 221, 222, 223, 311, 321, 331 can detect whether a corresponding cable is inserted into its respective socket. Therefore, when the detection sections 221, 222, 223, 311, 321, 331 detect that a corresponding cable is inserted into the socket, these detection sections transmit a corresponding value to a controller 160 of the memory card type connector 110.

Then, the controller 160 supports the connection between the socket into which the cable is inserted and the memory card type connector 110 according to the value transmitted from the detection sections 221, 222, 223, 311, 321, and 331. As a result, the cables and a portable electronic device 10, which are connected to each other through the sockets and the memory card type connector 110, i.e. through the unified connecting device 300, can be properly connected to each other and can be properly operated.

Here, the detection sections 221, 222, 223, 311, 321, 331 may be realized in various forms as in the above-mentioned embodiments. For example, the detection sections 221, 222, 223, 311, 321, and 331 may be realized by ON/OFF switches or optical sensors.

As mentioned above, since the unified connecting device according to various embodiments of the present general inventive concept includes a connector having an appearance in the form of a memory card and a plurality of sockets electrically connected to the connector, a plurality of cables having different appearances and different functions can be connected to one memory card socket using the unified connecting device according to the various embodiments described herein.

Therefore, since the unified connecting device according to the various embodiments can allow a plurality of cables having different appearances and different functions to be connected to one memory card socket, various cables having different functions can be connected even to a portable electronic device having one memory card socket using the unified connecting device according to the embodiments described herein.

Consequently, according to the unified connecting device of the various embodiments described herein, a portable electronic device does not need a plurality of sockets to connect various types of cables such as a power cable, a USB cable, and a firewire cable. Therefore, since a portable electronic device needs only one memory card socket, it can be made much slimmer and more compact.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A unified connecting device comprising:
a memory card type connector; and
a plurality of sockets electrically connected to the memory card type connector.

2. The unified connecting device according to claim 1, wherein the memory card type connector is inserted into a memory card socket provided in a portable electronic device.

3. The unified connecting device according to claim 1, wherein the memory card type connector comprises a connector body having the form of a memory card and a plurality of terminals installed on one side of the connector body so that a portion of the terminals are exposed to the outside of the connector body.

4. The unified connecting device according to claim 3, further comprising:
a controller to individually support connections between the sockets and the memory card type connector and is installed inside the connector body.

5. The unified connecting device according to claim 1, further comprising:
cables having different appearances and different functions and are inserted into the sockets respectively.

6. The unified connecting device according to claim 1, wherein the sockets comprise at least two sockets selected from a group consisting of a socket into which a USB cable is inserted, a socket into which an IEEE 1394 firewire cable is inserted, a socket into which a power source cable is inserted, a socket into which an earphone cable is inserted, a socket into which an S video cable is inserted, and a socket into which a data cable for a mobile phone is inserted.

7. The unified connecting device according to claim 1, further comprising:
detection sections to detect insertion of the cables and are provided in the sockets respectively.

8. A unified connecting device comprising:
a memory card type connector insertable into a memory card socket provided in a portable electronic device;
a plurality of sockets into which cables having different appearances and different functions are inserted; and
a connecting line electrically connecting the memory card type connector and the sockets.

9. The unified connecting device according to claim 8, wherein the memory card type connector comprises a connector body having the form of a memory card so as to be inserted into the memory card socket and a plurality of terminals installed on one side of the connector body so that a portion of the terminals is exposed to the outside of the connector body to be electrically connected to the memory card socket.

10. The unified connecting device according to claim 9, further comprising:
a controller to individually support connections between the sockets and the memory card type connector and is installed inside the connector body.

11. The unified connecting device according to claim 8, wherein the sockets comprise at least two sockets selected from a group comprising a socket into which a USB cable is inserted, a socket into which an IEEE 1394 firewire cable is inserted, a socket into which a power source cable is inserted, a socket into which an earphone cable is inserted, a socket into which an S video cable is inserted, and a socket into which a data cable for a mobile phone is inserted.

12. The unified connecting device according to claim 8, further comprising:
detection sections to detect insertion of the cables and are provided in the sockets respectively.

13. A unified connecting device, comprising:
a memory card type connector insertable into a memory port of a portable electronic device;
a plurality of sockets to receive different types of cables with respect to each other; and
a signal transmission part to transmit signals between the memory card type connector and the plurality of sockets.

14. The unified connecting device according to claim 13, wherein the signal transmission part includes a connecting line to physically connect the plurality of sockets and the memory card type connector.

15. The unified connecting device according to claim 13, wherein the signal transmission part includes a wireless connection unit to wirelessly connect the plurality of sockets and the memory card type connector.

16. The unified connecting device according to claim 13, further comprising:
a controller disposed within the memory card type connector to sense a signal received through the signal transmission part from the sockets and to signal to the electronic device which type of cable has been received by a corresponding sockets.

17. The unified connecting device according to claim 16, further comprising a detection section connected to each of the sockets to detect when a corresponding cable has been connected thereto and to send the signal to the controller from the respective socket.
